(19) United States
(12) Patent Application Publication
(10) Pub. No.: US 2018/0077551 A1
(43) Pub. Date: Mar. 15, 2018

(54) EMERGENCY RESPONSE FOR IOT AND/OR M2M DEVICES

(71) Applicant: Intel IP Corporation, Santa Clara, CA (US)

(72) Inventors: Rakesh Kalathil, San Diego, CA (US); Vishnusudhan Raghupathy, San Diego, CA (US)

(73) Assignee: Intel IP Corporation, Santa Clara, CA (US)

(21) Appl. No.: 15/263,342

(22) Filed: Sep. 12, 2016

(51) Int. Cl. H04W 4/22; H04W 72/04

(52) U.S. Cl. CPC H04W 4/22; H04L 67/12; H04W 72/0453

(57) ABSTRACT

Methods and apparatus relating to emergency response for IoT (Internet of Things) and/or M2M (Machine to Machine) devices are described. In an embodiment, one or more signals corresponding to an emergency application identifier are communicated. A receiving device enters an emergency mode of operation in response to detection of the one or more signals within a proximity of the receiving device. The emergency mode of operation causes the receiving device to perform one or more operations during a time period when the one or more signals are detectable. Other embodiments are also disclosed and claimed.

### FIELD

The present disclosure generally relates to the field of electronics. More particularly, an embodiment relates to emergency response for IoT (Internet of Things) and/or M2M (Machine-to-Machine) devices.

### BACKGROUND

Emergency response can have a direct impact on lives. For example, ambulance services provide out-of-hospital acute medical care and/or transport to a medical facility such as a hospital for those in need. In medical emergencies, the amount of time it takes an ambulance to reach a patient and/or transport a patient to a hospital can have a direct impact on the patient's survival chances.

Moreover, population density, topography, and other conditions (such as traffic) can have a significant effect on ambulance travel times. Consequently, there is often significant variation between the responsiveness of emergency medical services in various locales and countries. Unfortunately, many thousands of people die each year in western countries due to such delays. The situation is even worse in lesser developed countries.

One current solution is to allow ambulances to change the traffic lights with a remote control device. However, such remote control devices generally only work if they have a line-of-sight to traffic lights. This limits the range (e.g., due to distance limitations), security (e.g., where it may be easier to hack a line-of-sight device), and/or effectiveness of such remote control devices. For example, if an ambulance has to wait to trigger a traffic light change until it is within the line-of-sight range to the traffic signal, the ambulance would still have to wait for the existing traffic to clear (especially in congested metropolitan areas). This clearly affects the effectiveness of such devices.

Hence, reducing ambulance travel times can save many lives each year.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 shows an exemplary block diagram of the overall architecture of a 3GPP LTE network that includes one or more devices that are capable of implementing one or more techniques discussed herein, according to some embodiments.

FIGS. 2A and 2B show sample use cases in accordance with some embodiments.

FIGS. 3 and 4 illustrate flow diagrams that highlight emergency responses for a self-driving car and a traffic light, respectively, according to some embodiments.

FIG. 5 is a schematic, block diagram illustration of an information-handling system in accordance with one or more exemplary embodiments disclosed herein.

FIG. 6 is an isometric view of an exemplary embodiment of the information-handling system of FIG. 6 that optionally may include a touch screen in accordance with one or more embodiments disclosed herein.

FIG. 7 is a schematic, block diagram illustration of components of a wireless device in accordance with one or more exemplary embodiments disclosed herein.

FIGS. 8 and 9 illustrate block diagrams of embodiments of computing and processing systems, which may be utilized in various embodiments discussed herein.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

As mentioned above, emergency response can have a direct impact on lives. With the explosion of self-driving cars and IoT, there is tremendous interest in automating navigation and other such systems. For the above mentioned systems which use autonomous navigation or M2M/IOT, there is no standard mechanism currently to take autonomous emergency actions. For example, there is no standard mechanism for autonomous response of a self-driving car when in proximity of an emergency response vehicle.

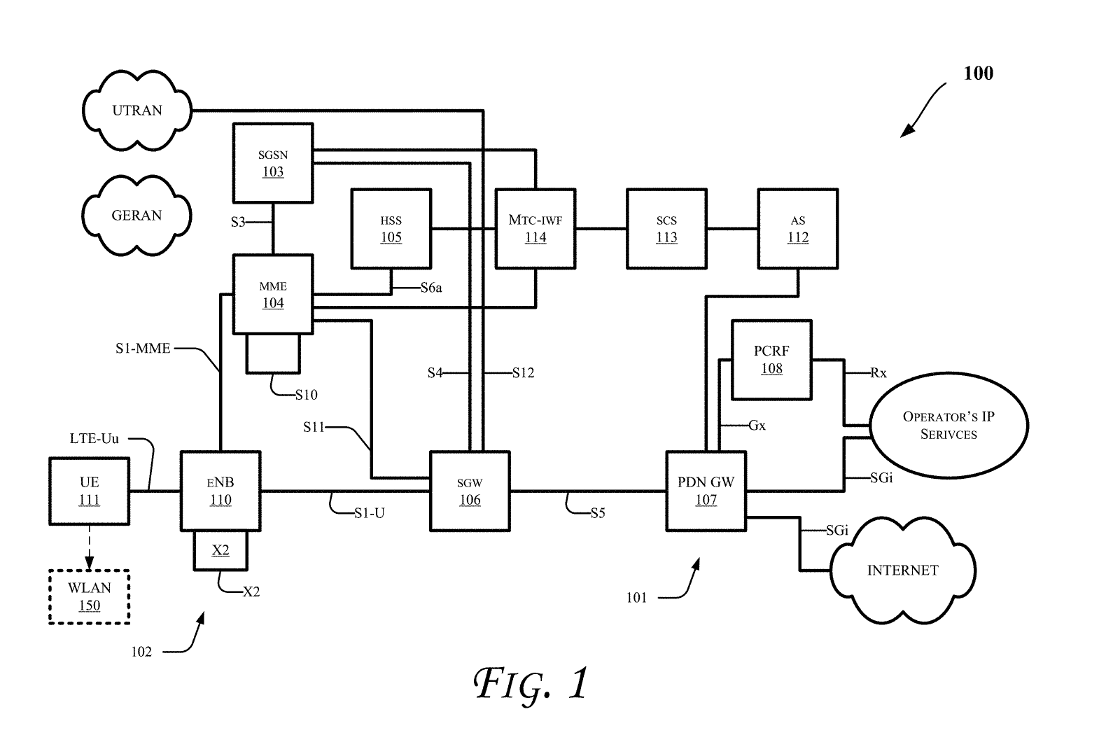

To this end, some embodiments relate to emergency response for communication devices (such as IoT (Internet of Things) and/or M2M (Machine-to-Machine) devices) that are capable of receiving signals to cause a moving object (e.g., a self-driving car) or a stationary object (e.g., a traffic light) to allow for faster passage of an emergency moving object (such as an ambulance). In an embodiment, an “IoT device” generally refers to a device which includes electronic processing circuitry (such as one or more processor/cores, PLA (Programmable Logic Array), SoC, ASIC (Application Specific Integrated Circuit), etc.), memory (e.g., to store software or firmware), one or more sensors (or is otherwise coupled to one or more sensors such as a camera, motion detector, etc.), and network connectivity to allow the IoT device to collect and/or exchange data. IoT devices are generally cheaper than traditional computing devices to allow for their proliferation at remote locations. IoT devices also reduce costs by using existing infrastructure (such as the Internet, a (third generation (3G) or fourth generation (4G) cellular/wireless network, etc.). More generally, an IoT device may include one or more components such as those discussed with reference to FIGS. 1-9.

In one embodiment (e.g., in the Physical Sidelink Discovery Channel (PSDCH) of a Third Generation Partnership Project (3GPP) Long Term Evolution (LTE) network (such as network 100 of FIG. 1)), emergency vehicle(s) transmit (or may otherwise cause transmission of) an emergency application ID (Identifier). PSDCH may allow for proximity communication, for example, where detection over PSDCH is performed for nearby devices. In some embodiments, the range for nearby device communication (e.g., via 3GPP sidelink channels or PSDCH) is about tens to about 100 s of meters. Other devices receive these application IDs, e.g., in SIB (System Information Block) or via other control signal(s), and may (e.g., continuously and/or periodically) monitor for these application IDs. Alternatively, PSS (Primary Synchronization Signal) or SSS (Secondary Synchronization Signal) values may be used instead of or in addition to the application IDs which may be discovered by a receiving device (e.g., user equipment (EU)), e.g., autonomously (and without any specific start/stop provisional from the network).

Embodiments are however not limited to PSDCH and any type of cellular channel or wireless communication can be used to transmit/exchange the information discussed herein. In an embodiment, to speed up the process, no additional or extra communication takes place with network ProSe (Proximity Sensing) regarding provisioning of discovery resources or monitoring of application ID. When other devices discover these predefined emergency application IDs, they (e.g., immediately) enter an emergency mode where they can respond to these emergency IDs and perform a predefined emergency operation. For extending the capability of these devices to perform emergency operation(s), the devices may be able to make an “Emergency Configuration Call” (a new Mobile Originated (MO) data call type) which may be given preference (e.g., by an operator/user) and provide the device with the appropriate configuration information for handing the emergency condition(s).

Additionally, while some embodiments are discussed with reference to ambulances, the embodiments are not limited to ambulances and may include any authorized vehicle such as emergency service vehicles (including vehicles transporting security/police staff, medical personnel, firefighters, etc.), and/or vehicles transporting dignitaries, sensitive content (such as organs for organ transplants operations and/or hazardous material), etc. In an embodiment, an IoT device is present on the authorized vehicle, one or more other non-authorized (also referred to herein as “normal”) vehicles, and/or on one or more (or all) traffic signals en route to the destination of the authorized vehicle. In one embodiment, the authorized vehicle may communicate through the cloud and/or M2M (or connected car) to reduce its travel time (or allow for safer passage) to its destination. Reduction of travel time or safe passage may not be the only reasons. For example, this communication could be used for performing any operation (such as, authorized vehicles may be drones, which enter an emergency mode in response to detecting a crash site and optionally start performing an operation like diverting traffic, patrolling the area, etc.). Authorized vehicles could also enter an emergency mode of operation, as mentioned in the above example.

FIG. 1 shows an exemplary block diagram of the overall architecture of a Third Generation Partnership Project (3GPP) Long Term Evolution (LTE) network 100 that includes one or more devices that are capable of implementing one or more techniques discussed herein, according to some embodiments. FIG. 1 also generally shows exemplary network elements and exemplary standardized interfaces. At a high level, network 100 comprises a Core Network (CN) 101 (also referred to as an Evolved Packet System (EPC)), and an air-interface access network E-UTRAN (Evolved Universal Terrestrial Radio Access Network) 102. CN 101 is responsible for the overall control of the various User Equipment (UE) coupled to the network and establishment of the bearers. CN 101 may include functional entities, such as a home agent and/or an ANDSF (Access Network Discovery and Selection Function) server or entity, although not explicitly depicted. E-UTRAN 102 is responsible for all radio-related functions.

Exemplary logical nodes of CN 101 include, but are not limited to, a Serving GPRS Support Node (SGSN) 103, Mobility Management Entity (MME) 104, a Home Subscriber Server (HSS) 105, a Serving Gateway (SGW) 106, a PDN Gateway (or PDN GW) 107, and a Policy and Charging Rules Function (PCRF) Manager logic 108. The functionality of each of the network elements of CN 101 is generally in accordance with various standards and is not described herein for simplicity. Each of the network elements of CN 101 are interconnected by exemplary standardized interfaces, some of which are indicated in FIG. 1, such as interfaces S3, S4, S5, etc.

While CN 101 includes many logical nodes, the E-UTRAN access network 102 is formed by at least one node, such as evolved NodeB 110 (Base Station (BS), eNB (or eNodeB that refers to evolved Node B)), which couples to one or more UE 111, of which only one is depicted in FIG. 1 for the sake of simplicity. UE 111 is also referred to herein as a Wireless Device (WD) and/or a Subscriber Station (SS), and may include an M2M (Machine to Machine) type device. In one example, UE 111 may be coupled to eNB by an LTE-Uu interface. In one exemplary configuration, a single cell of an E-UTRAN access network 102 provides one substantially localized geographical transmission point (e.g., having multiple antenna devices) that provides access to one or more UEs. In another exemplary configuration, a single cell of an E-UTRAN access network 102 provides multiple geographically substantially isolated transmission points (each having one or more antenna devices) with each transmission point providing access to one or more UEs simultaneously and with the signaling bits defined for the one cell so that all UEs share the same spatial signaling dimensioning.

For normal user traffic (as opposed to broadcast), there is no centralized controller in E-UTRAN; hence the E-UTRAN architecture is said to be flat. The eNBs can be interconnected with each other by an interface known as “X2” and to the EPC by an S1 interface. More specifically, an eNB is coupled to MME 104 by an S1 MME interface and to SGW 106 by an S1 U interface. The protocols that run between the eNBs and the UEs are generally referred to as the “AS protocols.” Details of the various interfaces can be in accordance with available standards and are not described herein for the sake of simplicity.

The eNB 110 hosts the PHYsical (PHY), Medium Access Control (MAC), Radio Link Control (RLC), and Packet Data Control Protocol (PDCP) layers, which are not shown in FIG. 1, and which include the functionality of user-plane header-compression and encryption. The eNB 110 also provides Radio Resource Control (RRC) functionality corresponding to the control plane, and performs many functions including radio resource management, admission control, scheduling, enforcement of negotiated Up Link (UL) QoS (Quality of Service), cell information broadcast, ciphering/deciphering of user and control plane data, and compression/decompression of DL/UL (Downlink/Uplink) user plane packet headers.

The RRC layer in eNB 110 covers all functions related to the radio bearers, such as radio bearer control, radio admission control, radio mobility control, scheduling and dynamic allocation of resources to UEs in both uplink and downlink, header compression for efficient use of the radio interface, security of all data sent over the radio interface, and connectivity to the EPC. The RRC layer makes handover decisions based on neighbor cell measurements sent by UE 111, generates pages for UEs 111 over the air, broadcasts system information, controls UE measurement reporting, such as the periodicity of Channel Quality Information (CQI) reports, and allocates cell-level temporary identifiers to active UEs 111. The RRC layer also executes transfer of UE context from a source eNB to a target eNB during handover, and provides integrity protection for RRC messages. Additionally, the RRC layer is responsible for the setting up and maintenance of radio bearers. Various types of (WLAN) may be supported such as any of those discussed herein.

As mentioned above in the background section, recently, significant momentum has started to build around the idea of a next generation, or Fifth Generation (5G), wireless communications technology. A wide range of applications and services may be used with 5G systems, such as: (a) Enhanced Mobile Broadband: providing higher data rates will continue to be a key driver in network development and evolution for 5G system (for example, it can be envisioned that a peak data rate of more than 10 Gps and a minimum guaranteed user data rate of at least 100 Mbps be supported for 5G system); (b) Massive Machine Type Communications (MTC): support of a massive number of Internet of Things (IoT) or MTC devices may become one key feature for 5G system (for example, where MTC devices used for many applications may utilize low operational power consumption and be expected to communicate with infrequent small burst transmissions); and/or (c) Ultra-reliable and low latency or mission critical communications: support of mission critical MTC applications for 5G system may provide extremely high level of reliable connectivity with guaranteed low latency, availability, and reliability-of-service.

As mentioned above, mobile communication has evolved significantly from early voice systems to today's highly sophisticated integrated communication platform. The next generation wireless communication system, 5G, aims to provide access to information and sharing of data anywhere, anytime by various users and applications. 5G is expected to be a unified network/system that target to meet vastly different and sometime conflicting performance dimensions and services. Such diverse multi-dimensional goals are driven by different services and applications. In general, 5G will evolve based on 3GPP LTE-Advanced with additional potential new Radio Access Technologies (RATs) to enrich people's lives with better, simpler, and more seamless wireless connectivity solutions. 5G aims to enable everything connected by wireless and deliver fast, rich content and services.

Some embodiments provide solutions for autonomous vehicles and other autonomous IoT devices to handle emergency situations. More particularly, an embodiment provides a standard method for devices to autonomously react to emergency conditions. Receiving devices can place an “Emergency configuration call” (e.g., using a new MO Data call type) including in the call the discovered Emergency application ID (Identifier). In this call, the network can configure the device (e.g., the device in an autonomous vehicle such as those discussed herein including an IoT and/or M2M device) with specific actions to perform depending on the emergency situation. This extends the device's capability to handle specific emergency conditions. By pre-defining and specifying the emergency IDs that would be used in a cell in SIB, the detection and reaction time may be reduced. In an embodiment, no policy configuration is required before each emergency ID transmission or detection.

Furthermore, as discussed herein various devices may communicate or exchange information with a “network” (or interchangeably a “cloud”). Such network may include one or more remote computing devices or servers (e.g., via eNB, ProSe server, LTE Positioning Protocol server, etc.) that provide the data for the information exchange. For example, a central dispatch entity may provide the configuration information when a device enters an emergency operation mode to assist with routing of a moving object or vehicle (such as an ambulance).

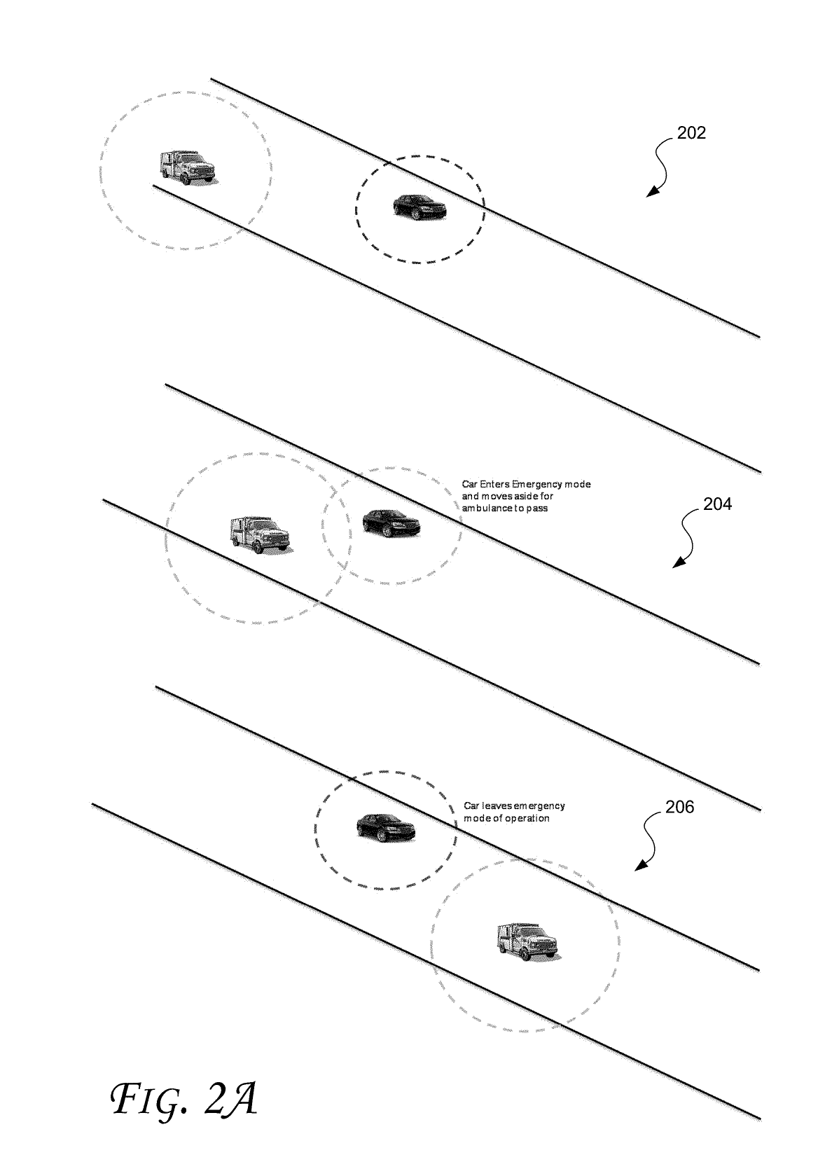

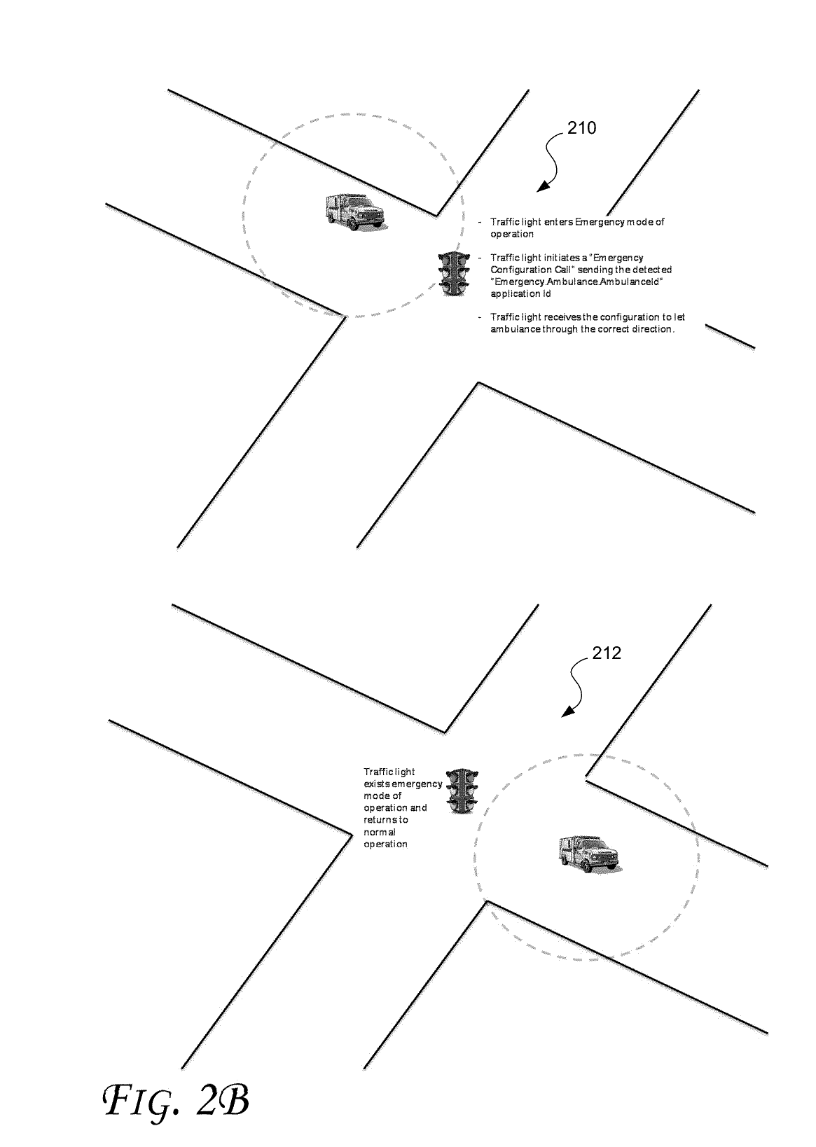

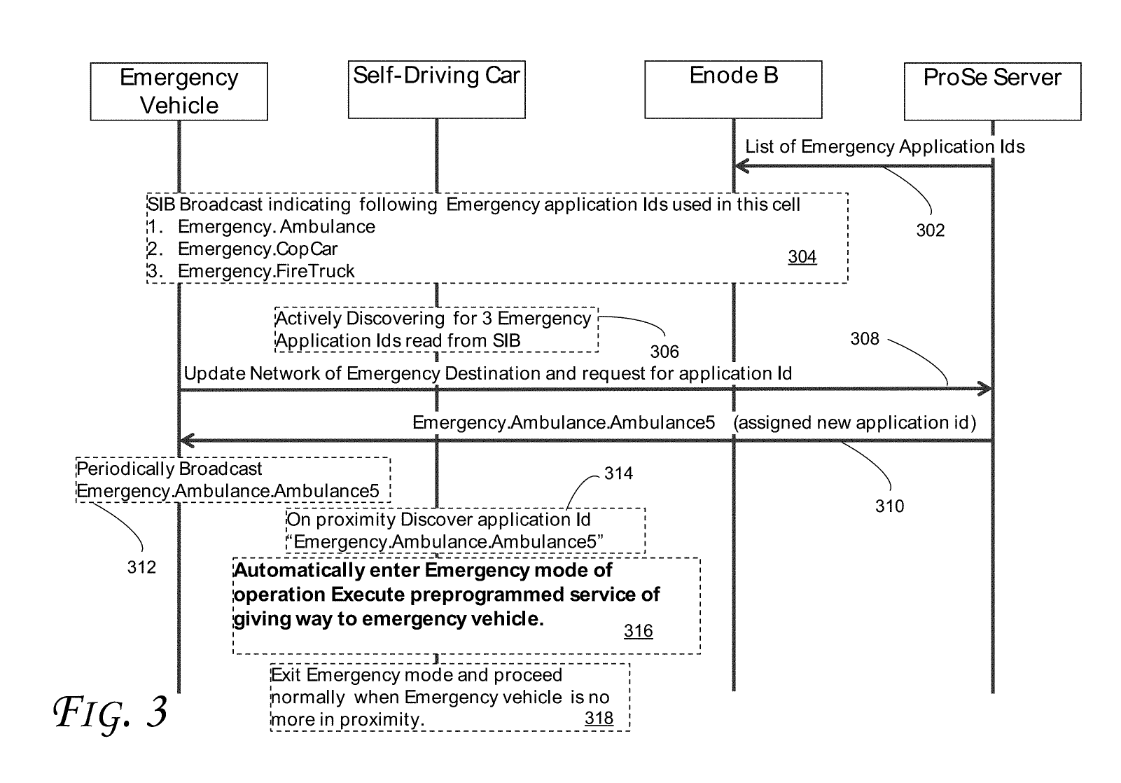

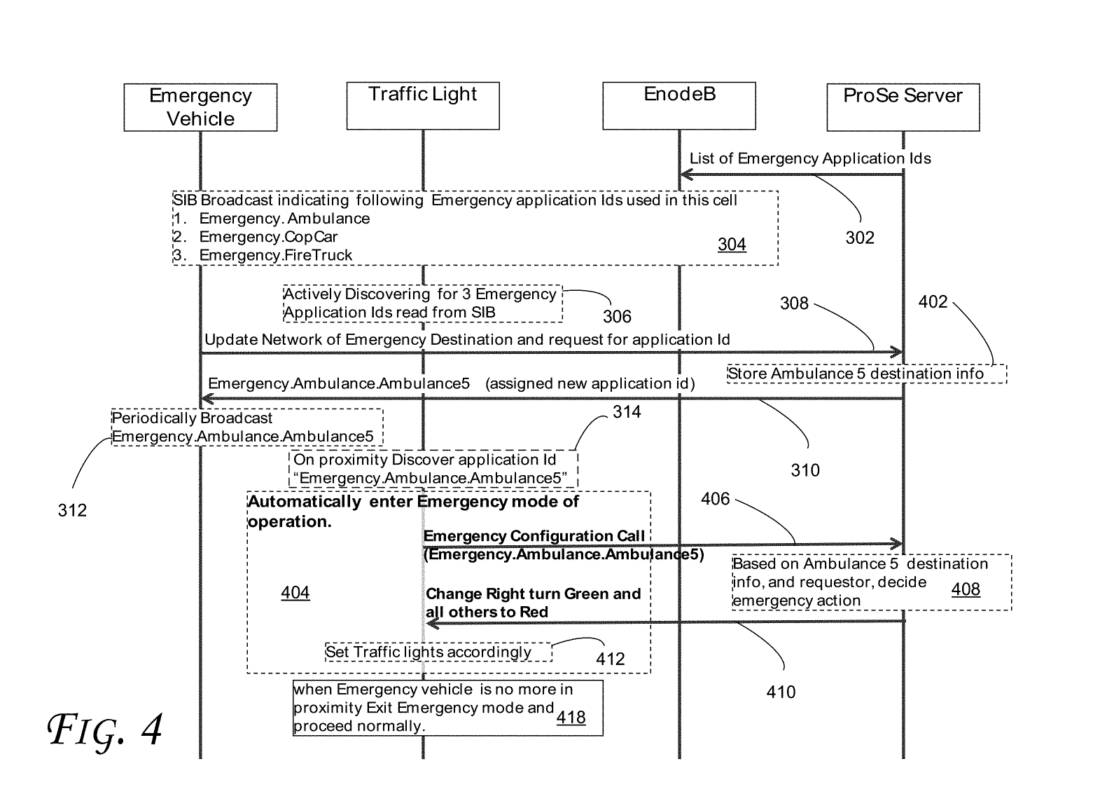

FIGS. 2A and 2B show sample use cases in accordance with some embodiments. FIGS. 3 and 4 illustrate flow diagrams that highlight responses to emergency vehicles for a self-driving car and a traffic light, respectively, according to some embodiments. However, embodiments discussed herein are not limited to these use cases and may be applied to a moving or mobile device (e.g., in a vehicle, carried by a user, etc.), IoT device, and/or M2M device. Moreover, in FIGS. 2A and 2B, the radius around the illustrated dotted circles shows a corresponding range for moving objects/vehicles.

As shown in FIG. 2A, an ambulance approaches a self-driving car (202) and once the ambulance is within the range of the self-driving car (204), the car enters emergency mode and moves aside to facilitate passing of the ambulance. The car then leaves the emergency mode of operation (206) after the ambulance exits the range.

FIG. 2B shows that a traffic light enters emergency mode of operation (210) once the ambulance is within range. The traffic light initiates an emergency configuration call, sending the detected “emergency.ambulance ambulanceID” application ID to the network. The traffic light receives the configuration from the network to let the ambulance through the correct direction. In an embodiment, the correct direction information is embedded in the received network information based on destination/routing information for the ambulance's trip.

Additionally, while some embodiments are discussed with reference to ambulances, the embodiments are not limited to ambulances and may include any authorized vehicle such as emergency service vehicles (including vehicles transporting security/police staff, medical personnel, firefighters, etc.), and/or vehicles transporting dignitaries, sensitive content (such as organs for organ transplants operations and/or hazardous material), etc. In an embodiment, an IoT device is present on the authorized vehicle, one or more other non-authorized (also referred to herein as “normal”) vehicles, and/or on one or more (or all) traffic signals en route to the destination of the authorized vehicle. In one embodiment, the authorized vehicle may communicate through the cloud and/or M2M (or connected car) to reduce its travel time (or allow for safer passage) to its destination or any other specific operation.

Referring to FIGS. 2A and 3, at operation 302, a ProSe server sends a list of emergency application IDs to eNB. At operation 304, the network broadcasts an emergency application ID (e.g., ‘Emergency.Ambulance’, ‘Emergency.CopCar’, ‘Emergancy.FireTruck’, etc.) in ProSe (Proximity Sensing) specific SIB 18 or 19 of 3GPPP. These SIBs may also specify the periodicity (or repetition period) and one or more resources to be allocated for emergency application IDs. The periodicity may be such that it serves the purpose of autonomous vehicular communication and traffic signal navigation. In an embodiment, a periodicity of about 1 second is used, e.g., to allow for discovery of the emergency IDs within 1 second.

At operation 306, all UEs (or receiving device(s)) read these application IDs from SIB and start discovery process for these application IDs automatically. Hence, in at least one embodiment, for these application IDs, devices do not need to contact the ProSe server for permission to discover. Moreover, at this operation, all devices may periodically discover these “emergency application IDs”.

At operation 308 (e.g., when an Ambulance starts its trip), the ambulance contacts the network and updates the network with its emergency destination (or some other important navigational information such as: is the ambulance alone or accompanied by other emergency vehicles; is the ambulance going to pick up a patient or travel to a hospital, what is the maximum speed of the vehicle; etc.) and requests a unique application ID from the ProSe server. Hence, the ambulance informs the network to allocate the resources to service the particular ID. In an embodiment, the routing information is used to optimize which devices receive the emergency information. Further, operation 308 allows the network to know the destination information of the emergency vehicle, allowing network to provide “emergency action configuration” that will be discussed at a later operation.

At operation 310, the network (e.g., ProSe server via eNB) provides a new/unique application ID to this ambulance, e.g., in the following format: “Emergency.Ambulance.AmbulanceId”. With the inclusion of “emergency” in the application ID, it is ensured that all emergency information is received. For example, inclusion of an emergency tag or indicator (e.g., “Emergency” as the first parameter) is to allow the receiving entity to use this for a broad search of all emergency conditions. This could be different for different services, but having the (e.g., first) keyword as emergency enables the receiving device(s) to know that this application ID is for an emergency purpose. And, in at least one embodiment, only in such case, the receiving entity/device can trigger an MO emergency configuration call, not otherwise. Hence, utilization of such indicator(s)/keyword(s) triggers the entry into an emergency mode and allows MO emergency configuration call. Further, in an embodiment, if any other service ID is present, then the above trigger is not satisfied. In one embodiment, the initial part of application ID is the same as that broadcast in SIB. This allows receiving devices to match the emergency part of application ID and be able to discover proximity of emergency vehicles.

At operation 312 (e.g., as the ambulance moves), the ambulance continuously broadcasts its application ID (e.g., in a periodic manner) using the resources as provided by network. At operation 314, when a receiving device discovers this application ID by matching “Emergency.Ambulance”, it (e.g., immediately) enters an “Emergency Mode” where (if already configured with an “Emergency Action”), it executes the action(s) at operation 316. For example, if the receiving device is a self-driving car, it takes action of moving to shoulder and giving way automatically at operation. Depending on the device, “Emergency Action” can initiate an “Emergency Configuration Call” with the complete discovered application ID to receive immediate “Emergency Action” (e.g., specific to this emergency application ID) to execute for the duration of this “Emergency period”.

At operation 318, once it is determined (e.g., by the discovery operation(s) indicate) that the emergency vehicle is not in proximity anymore, the self-driving car can resume its prior course (e.g., exit the shoulder area and continue on its prior course).

Referring to FIGS. 2B and 4, operations 302-314 may be the same or similar to the operations discussed with reference to FIG. 3. Furthermore, at operation 402, the ProSe server stores the ambulance's destination information (e.g., to subsequently provide configuration and traffic light behavior as further discussed below). At operation 314, when a receiving device discovers this application ID by matching “Emergency.Ambulance”, it (e.g., immediately) enters an “Emergency Mode” where (if already configured with an “Emergency Action”), it executes the action(s) at operation 404. As an example, a traffic light (on discovering this emergency application ID) could be configured to make the emergency call. More particularly, the traffic light initiates an Emergency Configuration Call and sends the complete application ID “Emergency.Ambulance.AmbulanceId” to the network at operation 406. Alternatively, the complete application ID may be sent separately from the emergency configuration call (e.g., before or after the call). In response, the ProSe server (or Network), e.g., based on the destination information initially received and the requestor can decide one or more emergency action(s) at operation 408. The network can configure the traffic light to change to a green signal in the requisite direction and unblock the emergency vehicle at operation 410. At operation 412, the traffic light operates in response to the configuration information of operation 410. At operation 418, once it is determined (e.g., by the discovery operation(s) indicate) that the emergency vehicle is not in proximity anymore, the traffic light exits the emergency mode of operation and resumes its normal traffic light operations.

In one or more embodiments, Mobile Terminated (MT) emergency configuration call may be used for nearby devices that have not detected the emergency vehicle on their own but need a change in configuration to support the device that has entered the emergency mode of operation. In one embodiment, the MT emergency configuration call may even be used for devices that are outside the range (such as the about tens to 100s of meters discussed herein). The emergency configuration in this case is generally time bound (and more particularly may uses an expiration timer as a part of the configuration to meet timing goal(s)). Moreover, the MT emergency configuration call may be triggered by the network in response to detection of an emergency condition from any of the devices. The MT call could be targeted towards devices that need to respond to an emergency condition but may not have detected the condition themselves. Hence, this approach could be useful if the network is aware of one or more devices near the device that detects the emergency, where the one or more devices need to behave in certain way but have not sensed the emergency beacon themselves.

Accordingly, in some embodiments, a device initiates a call without user intervention (e.g., where the call is of type data) and the call connects to a server (or application). The server knows the type of emergency per emergency ID and may then configure the device to behave in a certain way to address the emergency (e.g., passing of an ambulance). By contrast, existing emergency calls are made over voice networks and only connect to a particular operator (not an application or server). Also, existing calls are only initiated by a caller and not an IoT or M2M device. The calls initiated by some embodiments are routed faster within the system, e.g., since they are automated.

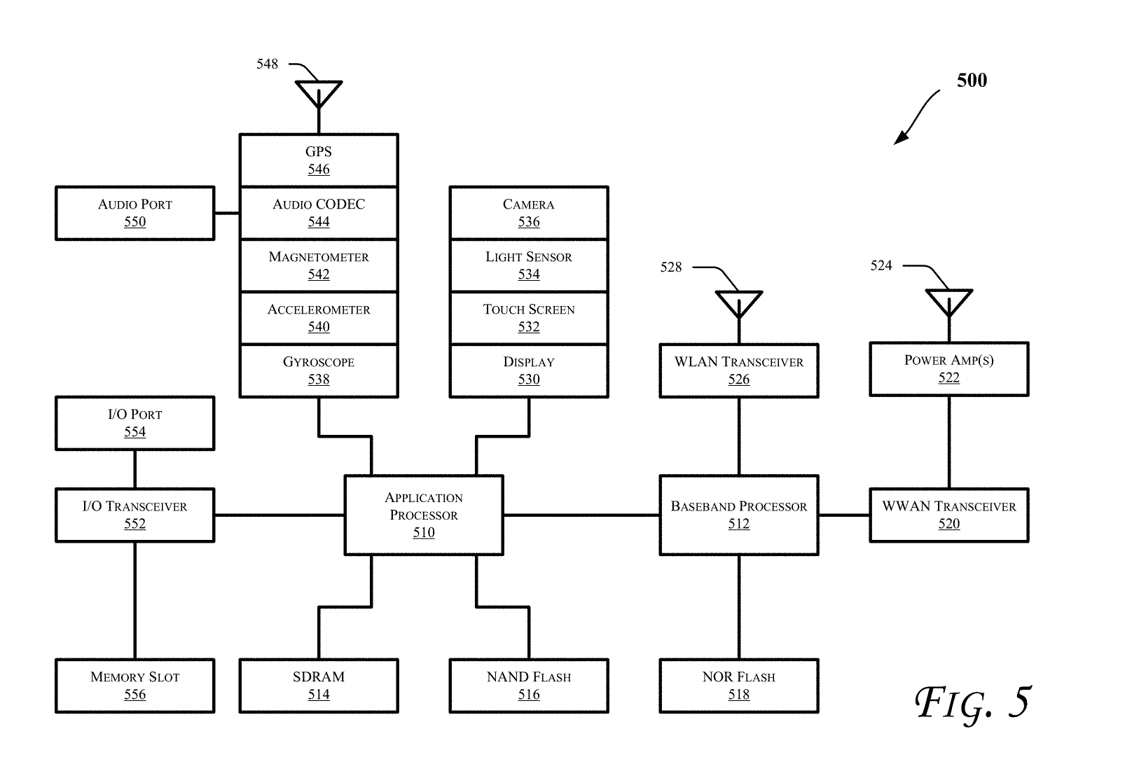

Referring now to FIG. 5, a block diagram of an information handling system capable of user equipment controlled mobility in an evolved radio access network in accordance with one or more embodiments will be discussed. Information handling system 500 of FIG. 5 may tangibly embody any one or more of the network elements described herein, above, including for example the elements of network 100 with greater or fewer components depending on the hardware specifications of the particular device. In one embodiment, information handling system 500 may tangibly embody a user equipment (UE) comprising circuitry to enter into an evolved universal mobile telecommunications system (UMTS) terrestrial radio access (E-UTRAN) Routing Area Paging Channel (ERA_PCH) state, wherein the UE is configured with an E-UTRAN Routing Area (ERA) comprising a collection of cell identifiers, and an Anchor identifier (Anchor ID) to identify an anchor evolved Node B (eNB) for the UE, select to a new cell without performing a handover procedure, and perform a cell update procedure in response to the UE selecting to the new cell, although the scope of the claimed subject matter is not limited in this respect. In another embodiment, information handling system 500 may tangibly embody a user equipment (UE) comprising circuitry to enter into a Cell Update Connected (CU_CNCTD) state, wherein the UE is configured with an Anchor identifier (Anchor ID) to identify an anchor evolved Node B (eNB) for the UE, select to a new cell, perform a cell update procedure in response to the UE selecting to the new cell, perform a buffer request procedure in response to the UE selecting to the new cell, and perform a cell update procedure to download buffered data and to perform data transmission with the new cell, although the scope of the claimed subject matter is not limited in this respect. Although information handling system 500 represents one example of several types of computing platforms, information handling system 500 may include more or fewer elements and/or different arrangements of elements than shown in FIG. 5, and the scope of the claimed subject matter is not limited in these respects.

In one or more embodiments, information handling system 500 may include an application processor 510 and a baseband processor 512. Application processor 510 may be utilized as a general-purpose processor to run applications and the various subsystems for information handling system 500. Application processor 510 may include a single core or alternatively may include multiple processing cores. One or more of the cores may comprise a digital signal processor or digital signal processing (DSP) core. Furthermore, application processor 510 may include a graphics processor or coprocessor disposed on the same chip, or alternatively a graphics processor coupled to application processor 510 may comprise a separate, discrete graphics chip. Application processor 510 may include on board memory such as cache memory, and further may be coupled to external memory devices such as synchronous dynamic random access memory (SDRAM) 514 for storing and/or executing applications during operation, and NAND flash 516 for storing applications and/or data even when information handling system 500 is powered off. In one or more embodiments, instructions to operate or configure the information handling system 500 and/or any of its components or subsystems to operate in a manner as described herein may be stored on an article of manufacture comprising a (e.g., non-transitory) storage medium. In one or more embodiments, the storage medium may comprise any of the memory devices shown in and described herein, although the scope of the claimed subject matter is not limited in this respect. Baseband processor 512 may control the broadband radio functions for information handling system 500. Baseband processor 512 may store code for controlling such broadband radio functions in a NOR flash 518. Baseband processor 512 controls a wireless wide area network (WWAN) transceiver 520 which is used for modulating and/or demodulating broadband network signals, for example for communicating via a 3GPP LTE or LTE-Advanced network or the like.

In general, WWAN transceiver 520 may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 6 (3rd Generation Partnership Project Release 12), 3GPP Rel. 7 (3rd Generation Partnership Project Release 12), 3GPP LTE Extra, LTE Licensed-Assisted Access (LAA), UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, millimeter wave (mmWave) standards in general for wireless systems operating at 10-90 GHz and above such as WiGig, IEEE 802.11ad, IEEE 802.11ay, and so on, and/or general telemetry transceivers, and in general any type of RF circuit or RFI sensitive circuit. It should be noted that such standards may evolve over time, and/or new standards may be promulgated, and the scope of the claimed subject matter is not limited in this respect.

The WWAN transceiver 520 couples to one or more power amps 542 respectively coupled to one or more antennas 524 for sending and receiving radio-frequency signals via the WWAN broadband network. The baseband processor 512 also may control a wireless local area network (WLAN) transceiver 526 coupled to one or more suitable antennas 528 and which may be capable of communicating via a Wi-Fi, Bluetooth®, and/or an amplitude modulation (AM) or frequency modulation (FM) radio standard including an IEEE 802.11 a/b/g/n standard or the like. It should be noted that these are merely example implementations for application processor 510 and baseband processor 512, and the scope of the claimed subject matter is not limited in these respects. For example, any one or more of SDRAM 514, NAND flash 516 and/or NOR flash 518 may comprise other types of memory technology such as magnetic memory, chalcogenide memory, phase change memory, or ovonic memory, and the scope of the claimed subject matter is not limited in this respect.

In one or more embodiments, application processor 510 may drive a display 530 for displaying various information or data, and may further receive touch input from a user via a touch screen 532 for example via a finger or a stylus. An ambient light sensor 534 may be utilized to detect an amount of ambient light in which information handling system 500 is operating, for example to control a brightness or contrast value for display 530 as a function of the intensity of ambient light detected by ambient light sensor 534. One or more cameras 536 may be utilized to capture images that are processed by application processor 510 and/or at least temporarily stored in NAND flash 516. Furthermore, application processor may couple to a gyroscope 538, accelerometer 540, magnetometer 542, audio coder/decoder (CODEC) 544, and/or global positioning system (GPS) controller 546 coupled to an appropriate GPS antenna 548, for detection of various environmental properties including location, movement, and/or orientation of information handling system 500. Alternatively, controller 546 may comprise a Global Navigation Satellite System (GNSS) controller. Audio CODEC 544 may be coupled to one or more audio ports 550 to provide microphone input and speaker outputs either via internal devices and/or via external devices coupled to information handling system via the audio ports 550, for example via a headphone and microphone jack. In addition, application processor 510 may couple to one or more input/output (I/O) transceivers 552 to couple to one or more I/O ports 554 such as a universal serial bus (USB) port, a high-definition multimedia interface (HDMI) port, a serial port, and so on. Furthermore, one or more of the I/O transceivers 552 may couple to one or more memory slots 556 for optional removable memory such as secure digital (SD) card or a subscriber identity module (SIM) card, although the scope of the claimed subject matter is not limited in these respects.

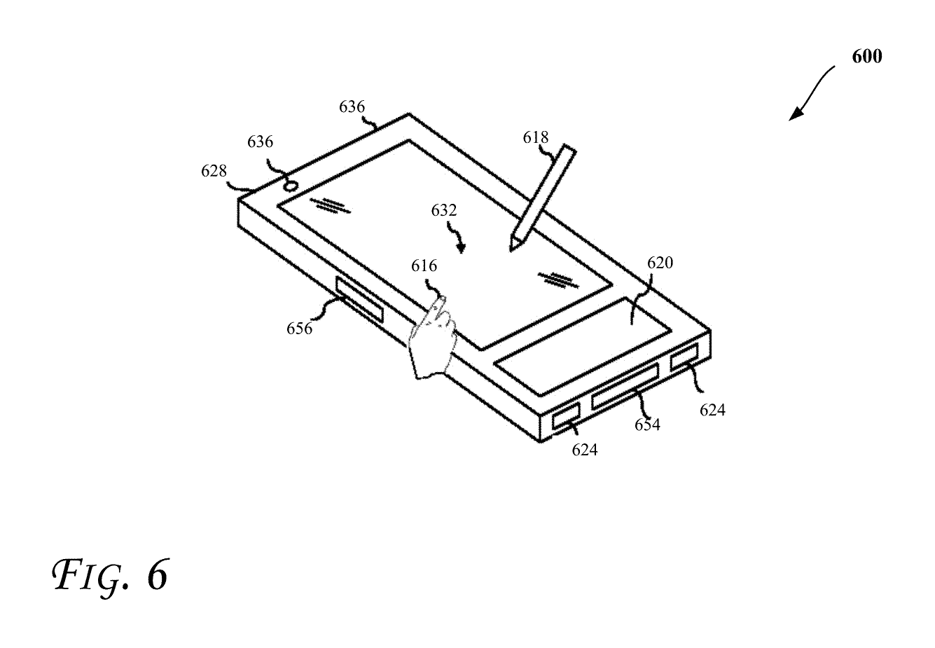

Referring now to FIG. 6, an isometric view of an information handling system of FIG. 5 that optionally may include a touch screen in accordance with one or more embodiments will be discussed. FIG. 6 shows an example implementation of information handling system 500 of FIG. 5 tangibly embodied as a cellular telephone, smartphone, or tablet type device or the like. The information handling system 500 may comprise a housing 610 having a display 530 which may include a touch screen 532 for receiving tactile input control and commands via a finger 616 of a user and/or a via stylus 618 to control one or more application processors 510. The housing 610 may house one or more components of information handling system 500, for example one or more application processors 510, one or more of SDRAM 514, NAND flash 516, NOR flash 518, baseband processor 512, and/or WWAN transceiver 520. The information handling system 500 further may optionally include a physical actuator area 620 which may comprise a keyboard or buttons for controlling information handling system via one or more buttons or switches. The information handling system 500 may also include a memory port or slot 556 for receiving non-volatile memory such as flash memory, for example in the form of a secure digital (SD) card or a subscriber identity module (SIM) card. Optionally, the information handling system 500 may further include one or more speakers and/or microphones 624 and a connection port 554 for connecting the information handling system 500 to another electronic device, dock, display, battery charger, and so on. In addition, information handling system 500 may include a headphone or speaker jack 628 and one or more cameras 536 on one or more sides of the housing 610. It should be noted that the information handling system 500 of FIG. 6 may include more or fewer elements than shown, in various arrangements, and the scope of the claimed subject matter is not limited in this respect.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

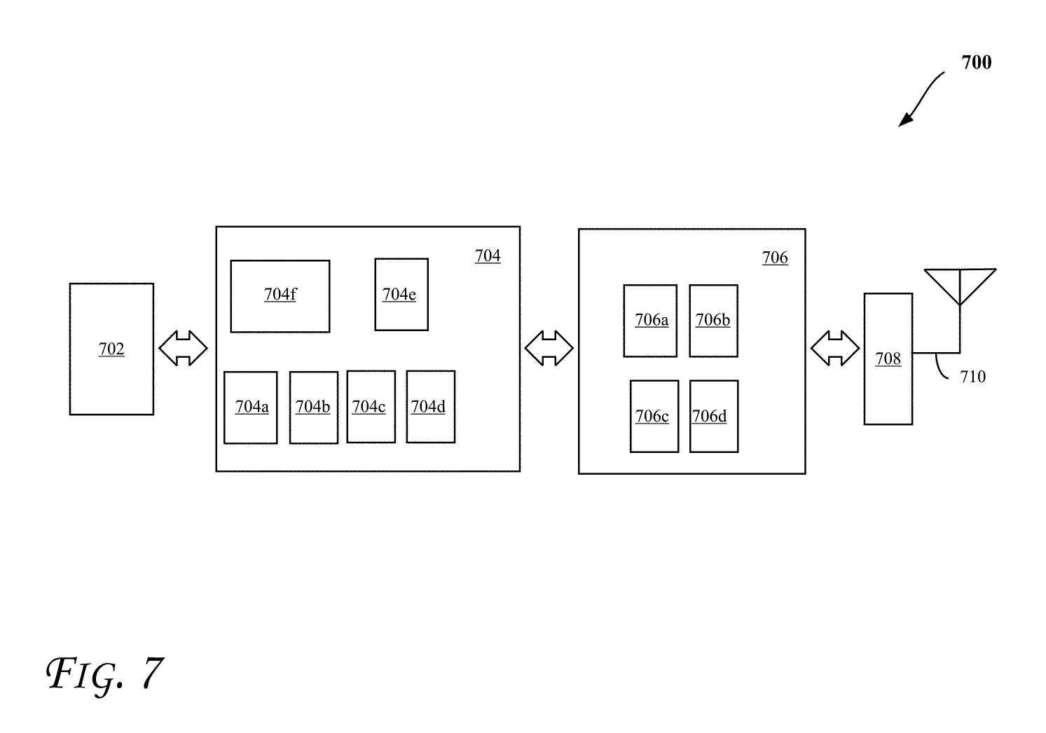

Referring now to FIG. 7, example components of a wireless device such as User Equipment (UE) device 110 in accordance with one or more embodiments will be discussed. In accordance with one embodiment, an eNB can include one or more components illustrated in and/or discussed with reference to FIG. 7. User equipment (UE) may correspond, for example, to UE 110 of network 100, although the scope of the claimed subject matter is not limited in this respect. In some embodiments, UE device 700 may include application circuitry 702, baseband circuitry 704, Radio Frequency (RF) circuitry 706, front-end module (FEM) circuitry 708 and one or more antennas 710, coupled together at least as shown.

Application circuitry 702 may include one or more application processors. For example, application circuitry 702 may include circuitry such as, but not limited to, one or more single-core or multi-core processors. The one or more processors may include any combination of general-purpose processors and dedicated processors, for example graphics processors, application processors, and so on. The processors may be coupled with and/or may include memory and/or storage and may be configured to execute instructions stored in the memory and/or storage to enable various applications and/or operating systems to run on the system.

Baseband circuitry 704 may include circuitry such as, but not limited to, one or more single-core or multi-core processors. Baseband circuitry 704 may include one or more baseband processors and/or control logic to process baseband signals received from a receive signal path of RF circuitry 706 and to generate baseband signals for a transmit signal path of the RF circuitry 706. Baseband processing circuitry 704 may interface with the application circuitry 702 for generation and processing of the baseband signals and for controlling operations of the RF circuitry 706. For example, in some embodiments, the baseband circuitry 504 may include a second generation (2G) baseband processor 704a, third generation (3G) baseband processor 704b, fourth generation (4G) baseband processor 704c, and/or one or more other baseband processors 704d for other existing generations, generations in development or to be developed in the future, for example fifth generation (5G), sixth generation (6G), and so on. Baseband circuitry 704, for example one or more of baseband processors 704a through 704d, may handle various radio control functions that enable communication with one or more radio networks via RF circuitry 706. The radio control functions may include, but are not limited to, signal modulation and/or demodulation, encoding and/or decoding, radio frequency shifting, and so on. In some embodiments, modulation and/or demodulation circuitry of baseband circuitry 704 may include Fast-Fourier Transform (FFT), precoding, and/or constellation mapping and/or demapping functionality. In some embodiments, encoding and/or decoding circuitry of baseband circuitry 504 may include convolution, tail-biting convolution, turbo, Viterbi, and/or Low Density Parity Check (LDPC) encoder and/or decoder functionality. Embodiments of modulation and/or demodulation and encoder and/or decoder functionality are not limited to these examples and may include other suitable functionality in other embodiments.

In some embodiments, baseband circuitry 704 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or Radio Resource Control (RRC) elements. Processor 704e of the baseband circuitry 704 may be configured to run elements of the protocol stack for signaling of the PHY, MAC, RLC, PDCP and/or RRC layers. In some embodiments, the baseband circuitry may include one or more audio digital signal processors (DSP) 704f The one or more audio DSPs 704f may include elements for compression and/or decompression and/or echo cancellation and may include other suitable processing elements in other embodiments. Components of the baseband circuitry may be suitably combined in a single chip, a single chipset, or disposed on a same circuit board in some embodiments. In some embodiments, some or all of the constituent components of baseband circuitry 704 and application circuitry 702 may be implemented together such as, for example, on a system on a chip (SOC).

In some embodiments, baseband circuitry 704 may provide for communication compatible with one or more radio technologies. For example, in some embodiments, baseband circuitry 704 may support communication with an evolved universal terrestrial radio access network (EUTRAN) and/or other wireless metropolitan area networks (WMAN), a wireless local area network (WLAN), a wireless personal area network (WPAN). Embodiments in which baseband circuitry 504 is configured to support radio communications of more than one wireless protocol may be referred to as multi-mode baseband circuitry.

RF circuitry 706 may enable communication with wireless networks using modulated electromagnetic radiation through a non-solid medium. In various embodiments, RF circuitry 706 may include switches, filters, amplifiers, and so on, to facilitate the communication with the wireless network. RF circuitry 706 may include a receive signal path which may include circuitry to down-convert RF signals received from FEM circuitry 708 and provide baseband signals to baseband circuitry 704. RF circuitry 706 may also include a transmit signal path which may include circuitry to up-convert baseband signals provided by the baseband circuitry 704 and provide RF output signals to FEM circuitry 708 for transmission.

In some embodiments, RF circuitry 706 may include a receive signal path and a transmit signal path. The receive signal path of RF circuitry 706 may include mixer circuitry 706a, amplifier circuitry 706b and filter circuitry 706c. The transmit signal path of RF circuitry 706 may include filter circuitry 706c and mixer circuitry 706a. RF circuitry 706 may also include synthesizer circuitry 706d for synthesizing a frequency for use by the mixer circuitry 706a of the receive signal path and the transmit signal path. In some embodiments, the mixer circuitry 706a of the receive signal path may be configured to down-convert RF signals received from FEM circuitry 708 based on the synthesized frequency provided by synthesizer circuitry 706d. Amplifier circuitry 706b may be configured to amplify the down-converted signals and the filter circuitry 706c may be a low-pass filter (LPF) or band-pass filter (BPF) configured to remove unwanted signals from the down-converted signals to generate output baseband signals. Output baseband signals may be provided to baseband circuitry 704 for further processing. In some embodiments, the output baseband signals may be zero-frequency baseband signals, although this is not a requirement. In some embodiments, mixer circuitry 706a of the receive signal path may comprise passive mixers, although the scope of the embodiments is not limited in this respect.

In some embodiments, mixer circuitry 706a of the transmit signal path may be configured to up-convert input baseband signals based on the synthesized frequency provided by synthesizer circuitry 706d to generate RF output signals for FEM circuitry 708. The baseband signals may be provided by the baseband circuitry 704 and may be filtered by filter circuitry 706c. Filter circuitry 706c may include a low-pass filter (LPF), although the scope of the embodiments is not limited in this respect.

In some embodiments, mixer circuitry 706a of the receive signal path and the mixer circuitry 706a of the transmit signal path may include two or more mixers and may be arranged for quadrature down conversion and/or up conversion respectively. In some embodiments, mixer circuitry 706a of the receive signal path and the mixer circuitry 706a of the transmit signal path may include two or more mixers and may be arranged for image rejection, for example Hartley image rejection. In some embodiments, mixer circuitry 506a of the receive signal path and the mixer circuitry 706a may be arranged for direct down conversion and/or direct up conversion, respectively. In some embodiments, mixer circuitry 706a of the receive signal path and mixer circuitry 706a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, RF circuitry 706 may include analog-to-digital converter (ADC) and digital-to-analog converter (DAC) circuitry, and baseband circuitry 504 may include a digital baseband interface to communicate with RF circuitry 706. In some dual-mode embodiments, separate radio integrated circuit (IC) circuitry may be provided for processing signals for one or more spectra, although the scope of the embodiments is not limited in this respect.

In some embodiments, synthesizer circuitry 706d may be a fractional-N synthesizer or a fractional N/N+1 synthesizer, although the scope of the embodiments is not limited in this respect as other types of frequency synthesizers may be suitable. For example, synthesizer circuitry 706d may be a delta-sigma synthesizer, a frequency multiplier, or a synthesizer comprising a phase-locked loop with a frequency divider.

Synthesizer circuitry 706d may be configured to synthesize an output frequency for use by mixer circuitry 706a of RF circuitry 706 based on a frequency input and a divider control input. In some embodiments, synthesizer circuitry 706d may be a fractional N/N+1 synthesizer.

In some embodiments, frequency input may be provided by a voltage controlled oscillator (VCO), although that is not a requirement. Divider control input may be provided by either baseband circuitry 704 or applications processor 702 depending on the desired output frequency. In some embodiments, a divider control input (e.g., N) may be determined from a look-up table based on a channel indicated by applications processor 702.

Synthesizer circuitry 706d of RF circuitry 706 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1, for example based on a carry out, to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 706d may be configured to generate a carrier frequency as the output frequency, while in other embodiments, the output frequency may be a multiple of the carrier frequency, for example twice the carrier frequency, four times the carrier frequency, and so on, and used in conjunction with quadrature generator and divider circuitry to generate multiple signals at the carrier frequency with multiple different phases with respect to each other. In some embodiments, the output frequency may be a local oscillator (LO) frequency (fLO). In some embodiments, RF circuitry 706 may include an in-phase and quadrature (IQ) and/or polar converter.

FEM circuitry 708 may include a receive signal path which may include circuitry configured to operate on RF signals received from one or more antennas 710, amplify the received signals and provide the amplified versions of the received signals to the RF circuitry 706 for further processing. FEM circuitry 708 may also include a transmit signal path which may include circuitry configured to amplify signals for transmission provided by RF circuitry 706 for transmission by one or more of the one or more antennas 710.

In some embodiments, FEM circuitry 708 may include a transmit/receive (TX/RX) switch to switch between transmit mode and receive mode operation. FEM circuitry 708 may include a receive signal path and a transmit signal path. The receive signal path of FEM circuitry 708 may include a low-noise amplifier (LNA) to amplify received RF signals and to provide the amplified received RF signals as an output, for example to RF circuitry 706. The transmit signal path of FEM circuitry 708 may include a power amplifier (PA) to amplify input RF signals, for example provided by RF circuitry 706, and one or more filters to generate RF signals for subsequent transmission, for example by one or more of antennas 710. In some embodiments, UE device 700 may include additional elements such as, for example, memory and/or storage, display, camera, sensor, and/or input/output (I/O) interface, although the scope of the claimed subject matter is not limited in this respect.

Furthermore, some embodiments may be applied in computing devices that include one or more processors (e.g., with one or more processor cores), such as those discussed with reference to FIGS. 1-9, including for example small form factor or mobile computing devices, e.g., an IoT device, M2M device, a smartphone, tablet, UMPC (Ultra-Mobile Personal Computer), laptop computer, Ultrabook™ computing device, wearable devices (such as a smart watch, smart glasses, etc.), 2 in 1 systems, etc. However, embodiments discussed herein are not limited to mobile computing devices and may be applied in any type of computing device, such as a work station, a server, a super computer, etc. Also, some embodiments are applied in computing devices that include a cooling fan as well as fanless computing devices.

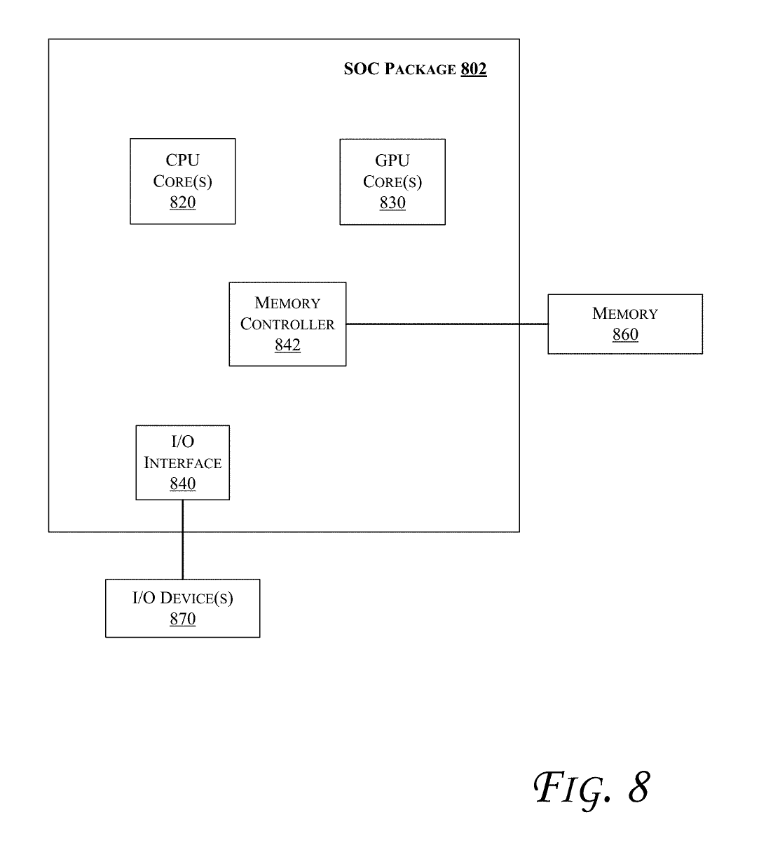

In some embodiments, an IoT device may be utilized. An IoT device may include various components (such as one or more components discussed with reference to FIGS. 1-9). Also, one or more embodiments may utilize a computing cloud (or more generally a “cloud”). The computing cloud may include various types of computing devices (such as those discussed herein with reference to FIGS. 1-9). These devices may be in digital communication via a cellular communication channel, a computer network, and/or the Internet. Also, one or more of the components discussed herein can be embodied as a System On Chip (SOC) device. FIG. 8 illustrates a block diagram of an SOC package in accordance with an embodiment. As illustrated in FIG. 8, SOC 802 includes one or more Central Processing Unit (CPU) cores 820, one or more Graphics Processor Unit (GPU) cores 830, an Input/Output (I/O) interface 840, and a memory controller 842. Various components of the SOC package 802 may be coupled to an interconnect or bus such as discussed herein with reference to the other figures. Also, the SOC package 802 may include more or less components, such as those discussed herein with reference to the other figures. Further, each component of the SOC package 820 may include one or more other components, e.g., as discussed with reference to the other figures herein. In one embodiment, SOC package 802 (and its components) is provided on one or more Integrated Circuit (IC) die, e.g., which are packaged into a single semiconductor device.

As illustrated in FIG. 8, SOC package 802 is coupled to a memory 860 via the memory controller 842. In an embodiment, the memory 860 (or a portion of it) can be integrated on the SOC package 802.

The I/O interface 840 may be coupled to one or more I/O devices 870, e.g., via an interconnect and/or bus such as discussed herein with reference to other figures. I/O device(s) 870 may include one or more of a keyboard, a mouse, a touchpad, a display, an image/video capture device (such as a camera or camcorder/video recorder), a touch screen, a speaker, or the like.

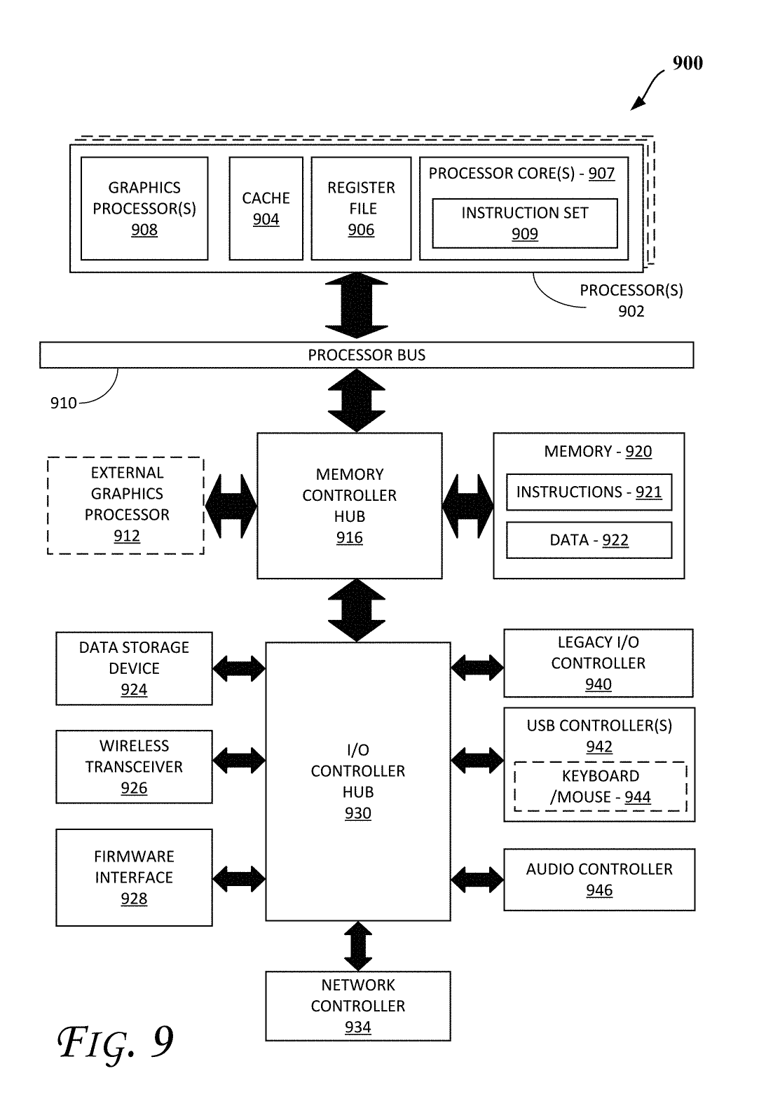

FIG. 9 is a block diagram of a processing system 900, according to an embodiment. In various embodiments the system 900 includes one or more processors 902 and one or more graphics processors 908, and may be a single processor desktop system, a multiprocessor workstation system, or a server system having a large number of processors 902 or processor cores 907. In on embodiment, the system 900 is a processing platform incorporated within a system-on-a-chip (SoC or SOC) integrated circuit for use in mobile, handheld, or embedded devices.

An embodiment of system 900 can include, or be incorporated within a server-based gaming platform, a game console, including a game and media console, a mobile gaming console, a handheld game console, or an online game console. In some embodiments system 900 is a mobile phone, smart phone, tablet computing device or mobile Internet device. Data processing system 900 can also include, couple with, or be integrated within a wearable device, such as a smart watch wearable device, smart eyewear device, augmented reality device, or virtual reality device. In some embodiments, data processing system 900 is a television or set top box device having one or more processors 902 and a graphical interface generated by one or more graphics processors 908.

In some embodiments, the one or more processors 902 each include one or more processor cores 907 to process instructions which, when executed, perform operations for system and user software. In some embodiments, each of the one or more processor cores 907 is configured to process a specific instruction set 909. In some embodiments, instruction set 909 may facilitate Complex Instruction Set Computing (CISC), Reduced Instruction Set Computing (RISC), or computing via a Very Long Instruction Word (VLIW). Multiple processor cores 907 may each process a different instruction set 909, which may include instructions to facilitate the emulation of other instruction sets. Processor core 907 may also include other processing devices, such a Digital Signal Processor (DSP).

In some embodiments, the processor 902 includes cache memory 904. Depending on the architecture, the processor 902 can have a single internal cache or multiple levels of internal cache. In some embodiments, the cache memory is shared among various components of the processor 902. In some embodiments, the processor 902 also uses an external cache (e.g., a Level-3 (L3) cache or Last Level Cache (LLC)) (not shown), which may be shared among processor cores 907 using known cache coherency techniques. A register file 906 is additionally included in processor 902 which may include different types of registers for storing different types of data (e.g., integer registers, floating point registers, status registers, and an instruction pointer register). Some registers may be general-purpose registers, while other registers may be specific to the design of the processor 902.

In some embodiments, processor 902 is coupled to a processor bus 910 to transmit communication signals such as address, data, or control signals between processor 902 and other components in system 900. In one embodiment the system 900 uses an exemplary ‘hub’ system architecture, including a memory controller hub 916 and an Input Output (I/O) controller hub 930. A memory controller hub 916 facilitates communication between a memory device and other components of system 900, while an I/O Controller Hub (ICH) 930 provides connections to I/O devices via a local I/O bus. In one embodiment, the logic of the memory controller hub 916 is integrated within the processor.

Memory device 920 can be a dynamic random access memory (DRAM) device, a static random access memory (SRAM) device, flash memory device, phase-change memory device, or some other memory device having suitable performance to serve as process memory. In one embodiment the memory device 920 can operate as system memory for the system 900, to store data 922 and instructions 921 for use when the one or more processors 902 executes an application or process. Memory controller hub 916 also couples with an optional external graphics processor 912, which may communicate with the one or more graphics processors 908 in processors 902 to perform graphics and media operations.

In some embodiments, ICH 930 enables peripherals to connect to memory device 920 and processor 902 via a high-speed I/O bus. The I/O peripherals include, but are not limited to, an audio controller 946, a firmware interface 928, a wireless transceiver 926 (e.g., Wi-Fi, Bluetooth), a data storage device 924 (e.g., hard disk drive, flash memory, etc.), and a legacy I/O controller 940 for coupling legacy (e.g., Personal System 2 (PS/2)) devices to the system. One or more Universal Serial Bus (USB) controllers 942 connect input devices, such as keyboard and mouse 944 combinations. A network controller 934 may also couple to ICH 930. In some embodiments, a high-performance network controller (not shown) couples to processor bus 910. It will be appreciated that the system 900 shown is exemplary and not limiting, as other types of data processing systems that are differently configured may also be used. For example, the I/O controller hub 930 may be integrated within the one or more processor 902, or the memory controller hub 916 and I/O controller hub 930 may be integrated into a discreet external graphics processor, such as the external graphics processor 912.

The following examples pertain to further embodiments. Example 1 includes an apparatus comprising: a receiving device having a communication device to receive one or more signals corresponding to an emergency application identifier; wherein the receiving device is to enter an emergency mode of operation in response to detection of the one or more signals within a threshold distance from the receiving device, wherein the emergency mode of operation is to cause the receiving device to perform one or more operations during a time period when the one or more signals are detectable. Example 2 includes the apparatus of example 1, wherein the one or more signals are to be transmitted over a Physical Sidelink Discovery Channel (PSDCH) of a Third Generation Partnership Project (3GPP) Long Term Evolution (LTE) network. Example 3 includes the apparatus of example 1, wherein a moving emergency vehicle is to transmit the one or more signals over a Physical Sidelink Discovery Channel (PSDCH) of a Third Generation Partnership Project (3GPP) Long Term Evolution (LTE) network. Example 4 includes the apparatus of example 1, wherein the communication device is to receive the one or more signals over a System Information Block (SIB) of a 3GPP LTE network. Example 5 includes the apparatus of example 1, wherein the emergency application identifier is to be transmitted as Primary Synchronization Signal (PSS) or Secondary Synchronization Signal (SSS)) values. Example 6 includes the apparatus of example 1, wherein the receiving device is to receive repetition period and/or one or more resources to be utilized the emergency mode of operation. Example 7 includes the apparatus of example 1, wherein the communication device is to receive the one or more signals autonomously. Example 8 includes the apparatus of example 1, wherein the one or more operations are to comprise: movement of the receiving device away from a path of a moving emergency vehicle or override of an operating state of an illumination device, wherein the illumination device is to be coupled to the communication device. Example 9 includes the apparatus of example 1, wherein the one or more operations are to comprise initiation of an emergency configuration call. Example 10 includes the apparatus of example 9, wherein the emergency configuration call is a high priority mobile originated call that is capable to cause configuration of at least one of the one or more operations. Example 11 includes the apparatus of example 9, wherein the receiving device is to transmit the emergency application identifier as part of or independent of the emergency configuration call. Example 12 includes the apparatus of example 1, wherein an IoT (Internet of Things) device is to comprise the communication device, processing logic, and memory. Example 13 includes the apparatus of example 1, wherein a moving emergency vehicle is to transmit the one or more signals, wherein the moving emergency vehicle is to comprise an emergency service vehicle, a vehicle carrying a dignitary, or a vehicle carrying sensitive content.

Example 14 includes an apparatus comprising: a transmitting device having a communication device to transmit one or more signals corresponding to an emergency application identifier to a receiving device; wherein the transmitting device is to transmit the one or more signals over a Physical Sidelink Discovery Channel (PSDCH) of a Third Generation Partnership Project (3GPP) Long Term Evolution (LTE) network. Example 15 includes the apparatus of example 14, wherein a moving emergency vehicle is to transmit the one or more signals, wherein the moving emergency vehicle is to comprise an emergency service vehicle, a vehicle carrying a dignitary, or a vehicle carrying sensitive content. Example 16 includes the apparatus of example 14, wherein the receiving device is to enter an emergency mode of operation in response to detection of the one or more signals within a threshold distance from the receiving device, wherein the emergency mode of operation is to cause the receiving device to perform one or more operations during a time period when the one or more signals are detectable. Example 17 includes the apparatus of example 14, wherein the receiving device is to receive the one or more signals over a System Information Block (SIB) of a 3GPP LTE network. Example 18 includes the apparatus of example 14, wherein the receiving device is to receive the one or more signals over a System Information Block (SIB) type 18 or type 19 of a 3GPP LTE network. Example 19 includes the apparatus of example 14, wherein an IoT (Internet of Things) device is to comprise the communication device, processing logic, and memory.

Example 20 includes an apparatus comprising: a receiving device having a communication device to receive one or more signals corresponding to an emergency application identifier; wherein the receiving device is to enter an emergency mode of operation in response to detection of the one or more signals, wherein the communication device is to receive the one or more signals via a Mobile Terminated emergency configuration call, wherein the emergency mode of operation is to cause the receiving device to perform one or more operations during a time period. Example 21 includes the apparatus of example 20, wherein the one or more signals are to be transmitted over a Physical Sidelink Discovery Channel (PSDCH) of a Third Generation Partnership Project (3GPP) Long Term Evolution (LTE) network. Example 22 includes the apparatus of example 20, wherein the time period is to be tracked by a timer.

Example 23 includes one or more computer-readable medium comprising one or more instructions that when executed on at least one processor configure the at least one processor to perform one or more operations to: cause communication of one or more signals corresponding to an emergency application identifier, wherein a receiving device is to enter an emergency mode of operation in response to detection of the one or more signals within a threshold distance from the receiving device, wherein the emergency mode of operation is to cause the receiving device to perform one or more operations during a time period when the one or more signals are detectable. Example 24 includes the computer-readable medium of example 23, further comprising one or more instructions that when executed on the at least one processor configure the at least one processor to perform one or more operations to cause transmission of the one or more signals over a Physical Sidelink Discovery Channel (PSDCH) of a Third Generation Partnership Project (3GPP) Long Term Evolution (LTE) network. Example 25 includes the computer-readable medium of example 23, further comprising one or more instructions that when executed on the at least one processor configure the at least one processor to perform one or more operations to cause receipt of the one or more signals over a System Information Block (SIB) of a 3GPP LTE network.

Example 26 includes one or more computer-readable medium comprising one or more instructions that when executed on at least one processor configure the at least one processor to perform one or more operations to: receive, at a receiving device having a communication device, one or more signals corresponding to an emergency application identifier; wherein the receiving device is to enter an emergency mode of operation in response to detection of the one or more signals, wherein the communication device is to receive the one or more signals via a Mobile Terminated emergency configuration call, wherein the emergency mode of operation is to cause the receiving device to perform one or more operations during a time period. Example 27 includes the computer-readable medium of example 26, wherein the one or more signals are to be transmitted over a Physical Sidelink Discovery Channel (PSDCH) of a Third Generation Partnership Project (3GPP) Long Term Evolution (LTE) network. Example 28 includes the computer-readable medium of example 26, wherein the time period is to be tracked by a timer.

Example 29 includes a method comprising: causing communication of one or more signals corresponding to an emergency application identifier, wherein a receiving device enters an emergency mode of operation in response to detection of the one or more signals within a threshold distance from the receiving device, wherein the emergency mode of operation causes the receiving device to perform one or more operations during a time period when the one or more signals are detectable. Example 30 includes the method of example 29, further comprising causing transmission of the one or more signals over a Physical Sidelink Discovery Channel (PSDCH) of a Third Generation Partnership Project (3GPP) Long Term Evolution (LTE) network. Example 31 includes the method of example 29, further comprising causing receipt of the one or more signals over a System Information Block (SIB) of a 3GPP LTE network.

Example 32 includes a method comprising: receiving, at a receiving device having a communication device, one or more signals corresponding to an emergency application identifier; wherein the receiving device enters an emergency mode of operation in response to detection of the one or more signals, wherein the communication device receives the one or more signals via a Mobile Terminated emergency configuration call, wherein the emergency mode of operation causes the receiving device to perform one or more operations during a time period. Example 33 includes the method of example 32, further comprising transmitting the one or more signals over a Physical Sidelink Discovery Channel (PSDCH) of a Third Generation Partnership Project (3GPP) Long Term Evolution (LTE) network. Example 34 includes the method of example 32, further comprising tracking the time period by a timer.

Example 35 includes an apparatus comprising means to perform a method as set forth in any preceding example. Example 36 comprises machine-readable storage including machine-readable instructions, when executed, to implement a method or realize an apparatus as set forth in any preceding example.

In various embodiments, the operations discussed herein, e.g., with reference to FIGS. 1-9, may be implemented as hardware (e.g., logic circuitry), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIGS. 1-9.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a receiving device having a communication device to receive one or more signals corresponding to an emergency application identifier;
wherein the receiving device is to enter an emergency mode of operation in response to detection of the one or more signals within a threshold distance from the receiving device, wherein the emergency mode of operation is to cause the receiving device to perform one or more operations during a time period when the one or more signals are detectable, wherein the receiving device is to receive one or more resources to be utilized during the emergency mode of operation, wherein the one or more resources are to be allocated for the emergency application identifier.

2. The apparatus of claim 1, wherein the one or more signals are to be transmitted over a Physical Sidelink Discovery Channel (PSDCH) of a Third Generation Partnership Project (3GPP) Long Term Evolution (LTE) network.

3. The apparatus of claim 1, wherein a moving emergency vehicle is to transmit the one or more signals over a Physical Sidelink Discovery Channel (PSDCH) of a Third Generation Partnership Project (3GPP) Long Term Evolution (LTE) network.

4. The apparatus of claim 1, wherein the communication device is to receive the one or more signals over a System Information Block (SIB) of a 3GPP LTE network.

5. The apparatus of claim 1, wherein the emergency application identifier is to be transmitted as Primary Synchronization Signal (PSS) or Secondary Synchronization Signal (SSS)) values.

6. The apparatus of claim 1, wherein the receiving device is to receive a repetition period to be utilized during the emergency mode of operation.

7. The apparatus of claim 1, wherein the communication device is to receive the one or more signals autonomously.

8. The apparatus of claim 1, wherein the one or more operations are to comprise: movement of the receiving device away from a path of a moving emergency vehicle or override of an operating state of an illumination device, wherein the illumination device is to be coupled to the communication device.

9. The apparatus of claim 1, wherein the one or more operations are to comprise initiation of an emergency configuration call.

10. The apparatus of claim 9, wherein the emergency configuration call is a high priority mobile originated call that is capable to cause configuration of at least one of the one or more operations.

11. The apparatus of claim 9, wherein the receiving device is to transmit the emergency application identifier as part of or independent of the emergency configuration call.

12. The apparatus of claim 1, wherein an IoT (Internet of Things) device is to comprise the communication device, processing logic, and memory.

13. The apparatus of claim 1, wherein a moving emergency vehicle is to transmit the one or more signals, wherein the moving emergency vehicle is to comprise an emergency service vehicle, a vehicle carrying a dignitary, or a vehicle carrying sensitive content.

14. An apparatus comprising:
a transmitting device having a communication device to transmit one or more signals corresponding to an emergency application identifier to a receiving device;
wherein the transmitting device is to transmit the one or more signals over a Physical Sidelink Discovery Channel (PSDCH) of a Third Generation Partnership Project (3GPP) Long Term Evolution (LTE) network, wherein the receiving device is to receive one or more resources to be utilized during an emergency mode of operation, wherein the one or more resources are to be allocated for the emergency application identifier.

15. The apparatus of claim 14, wherein a moving emergency vehicle is to transmit the one or more signals, wherein the moving emergency vehicle is to comprise an emergency service vehicle, a vehicle carrying a dignitary, or a vehicle carrying sensitive content.

16. The apparatus of claim 14, wherein the receiving device is to enter the emergency mode of operation in response to detection of the one or more signals within a threshold distance from the receiving device, wherein the emergency mode of operation is to cause the receiving device to perform one or more operations during a time period when the one or more signals are detectable.

17. The apparatus of claim 14, wherein the receiving device is to receive the one or more signals over a System Information Block (SIB) of a 3GPP LTE network.

18. The apparatus of claim 14, wherein the receiving device is to receive the one or more signals over a System Information Block (SIB) type 18 or type 19 of a 3GPP LTE network.

19. The apparatus of claim 14, wherein an IoT (Internet of Things) device is to comprise the communication device, processing logic, and memory.

20. An apparatus comprising:
a receiving device having a communication device to receive one or more signals corresponding to an emergency application identifier;
wherein the receiving device is to enter an emergency mode of operation in response to detection of the one or more signals, wherein the communication device is to receive the one or more signals via a Mobile Terminated emergency configuration call, wherein the emergency mode of operation is to cause the receiving device to perform one or more operations during a time period, wherein the receiving device is to receive one or more resources to be utilized during the emergency mode of operation, wherein the one or more resources are to be allocated for the emergency application identifier.

21. The apparatus of claim 20, wherein the one or more signals are to be transmitted over a Physical Sidelink Discovery Channel (PSDCH) of a Third Generation Partnership Project (3GPP) Long Term Evolution (LTE) network.

22. The apparatus of claim 20, wherein the time period is to be tracked by a timer.

23. One or more non-transitory computer-readable medium comprising one or more instructions that when executed on at least one processor configure the at least one processor to perform one or more operations to:
cause communication of one or more signals corresponding to an emergency application identifier, wherein a receiving device is to enter an emergency mode of operation in response to detection of the one or more signals within a threshold distance from the receiving device, wherein the emergency mode of operation is to cause the receiving device to perform one or more operations during a time period when the one or more signals are detectable, wherein the receiving device is to receive one or more resources to be utilized during the emergency mode of operation, wherein the one or more resources are to be allocated for the emergency application identifier.

24. The one or more non-transitory computer-readable medium of claim 23, further comprising one or more instructions that when executed on the at least one processor configure the at least one processor to perform one or more operations to cause transmission of the one or more signals over a Physical Sidelink Discovery Channel (PSDCH) of a Third Generation Partnership Project (3GPP) Long Term Evolution (LTE) network.

25. The one or more non-transitory computer-readable medium of claim 23, further comprising one or more instructions that when executed on the at least one processor configure the at least one processor to perform one or more operations to cause receipt of the one or more signals over a System Information Block (SIB) of a 3GPP LTE network.
